(19) United States
(12) Patent Application Publication
(10) Pub. No.: US 2025/0220103 A1
(43) Pub. Date: Jul. 3, 2025

(54) CALL SUPPORT DEVICE

(71) Applicant: HONDA MOTOR CO., LTD., Tokyo (JP)

(72) Inventors: Shinichi Kobayashi, Tokyo (JP); Takashi Kawachi, Tokyo (JP); Azumi Asakawa, Tokyo (JP)

(21) Appl. No.: 18/982,636

(22) Filed: Dec. 16, 2024

(30) Foreign Application Priority Data
Dec. 28, 2023 (JP) 2023-223248

(51) Int. Cl. H04M 1/72409

(52) U.S. Cl. CPC H04M 1/724098

(57) ABSTRACT

A moving body support device includes: a call control unit, which causes a moving body communication unit provided in a moving body to transmit a voice input into a moving body microphone to a communication terminal, and which makes a moving body call; a microphone activation control unit which switches the moving body microphone between an on state and an off state in response to an operation on a microphone switch provided in the moving body; and a microphone off notification unit which causes a moving body notification unit provided in the moving body to output a microphone off state notification, in a state in which the moving body microphone is in the off state, and when making the moving body call.

### INCORPORATION BY REFERENCE

The present application claims priority under 35 U.S.C. §119 to Japanese Patent Application No. 2023-223248 filed on Dec. 28, 2023. The content of the application is incorporated herein by reference in its entirety.

### BACKGROUND

### Technical Field

The present invention relates to a call support device.

### Related Art

There has been conventionally known a vehicular device that communicates with a mobile telephone brought into a vehicle by an occupant of the vehicle and that performs a mirroring operation of displaying a screen of the mobile telephone on a vehicular display provided in the vehicle (see, for example, JP 2012-213141 A). In the above vehicular device, a call start button is displayed on the vehicular display. In a case where a call made by the mobile telephone is started within a predetermined period of time from the time when an operation on the call start button is detected, switching is made to a hands-free call that is a call made by the mobile telephone using a microphone and a speaker provided in the vehicle.

### SUMMARY

In the conventional vehicular device, by the way, the microphone provided in the vehicle is set to be on all the time, while the vehicle is in a power-on state (ignition-on state). In this case, it is assumed that an occupant of the vehicle is worried that conversation voices between occupants in the vehicle are input into the microphone and leak to the outside, and therefore desires to turn off the microphone from the viewpoint of privacy. Hence, it is conceivable to switch on and off the microphone of the vehicle in accordance with an operation of the occupant. However, in a case where it is possible to switch on and off the microphone of the vehicle in this manner, when the microphone is in off state, a hands-free call using the microphone of the vehicle is unavailable. Then, in a case where the occupant tries to make the hands-free call using the microphone of the vehicle without recognizing that the microphone of the vehicle is in off state, the occupant does not know the reason why the hands-free call is unavailable. This may give the occupant a sense of incongruity or a sense of unease. Therefore, it is an object of the present application to suppress uneasy feeling of the occupant.

In order to address the above issues, it is an object of the present application to suppress degradation in operation performance of a moving body call, such as a hands-free call or an in-vehicle video conference using a microphone provided in the moving body, and to enable protection of privacy of occupants by turning off the microphone provided in the moving body. In addition, the present application further improves traffic safety, and contributes to development of a sustainable transportation system, accordingly.

According to an aspect for achieving the above object, a call support device that supports a moving body call made by a communication terminal that has been brought into the moving body, the moving body call using a moving body microphone provided in the moving body, and the call support device includes: a call control unit configured to transmit a voice input into the moving body microphone to the communication terminal from a moving body communication unit provided in the moving body, and to make the moving body call; a microphone activation control unit configured to switch the moving body microphone between an on state and an off state in response to an operation on a microphone switch provided in the moving body; and a microphone off notification unit configured to cause a moving body notification unit provided in the moving body to output a microphone off state notification, in a case where the moving body microphone is in the off state and when making the moving body call.

In the above call support device, the moving body notification unit may be a display, and the microphone off notification unit may perform processing of causing the display to display a microphone off notification image indicating that it is necessary to turn on the moving body microphone in order to make the moving body call, as an output of the microphone off state notification.

In the above call support device, in a state in which the microphone off notification image is displayed on the display, when the microphone activation control unit switches the moving body microphone from the off state to the on state in response to an operation on the microphone switch, the call control unit may switch to the moving body call.

In the above call support device, in a case where the communication terminal detects switching a terminal call for making the call on the communication terminal using a terminal microphone provided in the communication terminal to the moving body call, and in a case where the moving body microphone is in the off state and the microphone off notification image is displayed on the display, the call control unit may maintain a state in which the terminal call is being made, when an operation of turning off the moving body microphone is performed on the microphone switch.

In the above call support device, in a state in which communication is established between the communication terminal and the moving body communication unit, when the communication terminal receives an incoming call, the call control unit may display, on the display, an incoming call notification image for notifying the incoming call, and when the incoming call is answered from the incoming call notification image, and while the moving body microphone is in the off state and the microphone off notification image is displayed on the display, the call control unit may continuously display the incoming call notification image on the display, when an operation of turning off the moving body microphone is performed on the microphone switch.

In the above call support device, in a state in which communication is established between the communication terminal and the moving body communication unit, the call control unit may display, on the display, a call start button for giving an instruction to start the call made by the communication terminal; and when the call start button is operated, and while the moving body microphone is in the off state and the microphone off notification image is displayed on the display, the call control unit may continuously display the call start button on the display, when an operation of turning off the moving body microphone is performed on the microphone switch.

In the above call support device, while the moving body call is being made, when an operation of turning off the moving body microphone is performed on the microphone switch, the call control unit may display, on the display, a microphone off confirmation image for notifying that the moving body call becomes unavailable, when the moving body microphone is turned off.

In the above call support device, the display may be a touch panel display, and the call control unit may cause the display to display the microphone off confirmation image including a microphone off decision button for deciding an instruction to turn off the moving body microphone, and may turn off the moving body microphone, when the microphone off decision button is operated.

In the above call support device, a moving state recognition unit configured to recognize that the moving body is in a moving state may be further included, and when the moving state recognition unit recognizes that the moving body is in the moving state, and while the moving body call is being made, the microphone activation control unit may prohibit the moving body microphone from being switched to the off state.

According to the above call support device, it becomes possible to suppress degradation in operation performance of a moving body call using a microphone provided in the moving body, and to protect privacy of occupants by turning off the microphone provided in the moving body.

### BRIEF DESCRIPTION OF DRAWINGS

FIG. 1 is a configuration diagram of a vehicle in which a call support device is mounted;

FIG. 2 is a configuration diagram of a call support device;

FIG. 3 is an explanatory diagram of a microphone off notification image and a call operation image;

FIG. 4 is an explanatory diagram of an image during a hands-free call;

FIG. 5 is an explanatory diagram of a microphone off confirmation image;

FIG. 6 is a flowchart of handling processing in a case where a moving body microphone is in off state;

FIG. 7 is a flowchart of incoming call handling processing;

FIG. 8 is a flowchart of outgoing call handling processing; and

FIG. 9 is a flowchart of handling processing during a moving body hands-free call.

### DETAILED DESCRIPTION

### 1. Configuration of Vehicle

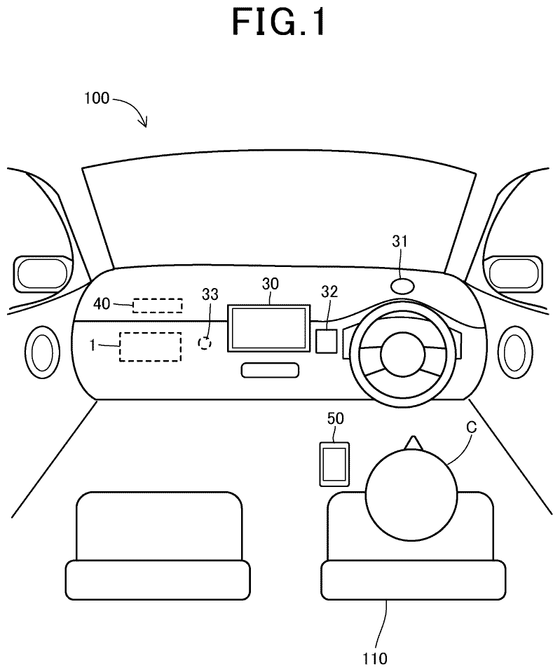

A configuration of a vehicle 100, in which a call support device 1 in the present embodiment is mounted, will be described with reference to FIG. 1. The vehicle 100 is a four-wheeled vehicle, and corresponds to a moving body in the present disclosure. The vehicle 100 includes a call support device 1 and a moving body communication unit 40. The moving body communication unit 40 communicates in a wireless or wired manner with a communication terminal 50, which is brought into the vehicle 100 by an occupant C (the driver in FIG. 1) of the vehicle 100. The wireless communication is performed in accordance with short-range communication standards, such as Bluetooth (registered trademark).

A display 30, a moving body microphone 31, and a moving body speaker 32 are provided on a front side of a driver's seat 110 of the vehicle 100 (dashboard or the like). The display 30 is a touch panel display in which a touch sensor is disposed on a surface of a flat panel display device such as an LCD or an organic EL. The display 30 corresponds to a moving body notification unit in the present disclosure. Furthermore, the vehicle 100 includes a speed sensor 33, which detects a traveling speed of the vehicle 100.

Although details will be described later, the call support device 1 switches on and off the moving body microphone 31 in response to a touch operation by the occupant C on the display 30. In addition, while the communication between the moving body communication unit 40 and the communication terminal 50 is established, the call support device 1 controls a moving body call made by the communication terminal 50 with a person on the other end of the telephone, by transmitting voices of the occupant C input into the moving body microphone 31 to the communication terminal 50, and outputs, from the moving body speaker 32, voices of the person on the other end of the telephone transmitted from the communication terminal 50. As the moving body call, various calls made by the communication terminal 50 using a speaker and a microphone provided in the vehicle 100 are included, such as a hands-free call and an in-vehicle video conference. Hereinafter, a case where the occupant C uses the function of the hands-free call will be described as an example of the moving body call.

### 2. Configuration of Call Support Device

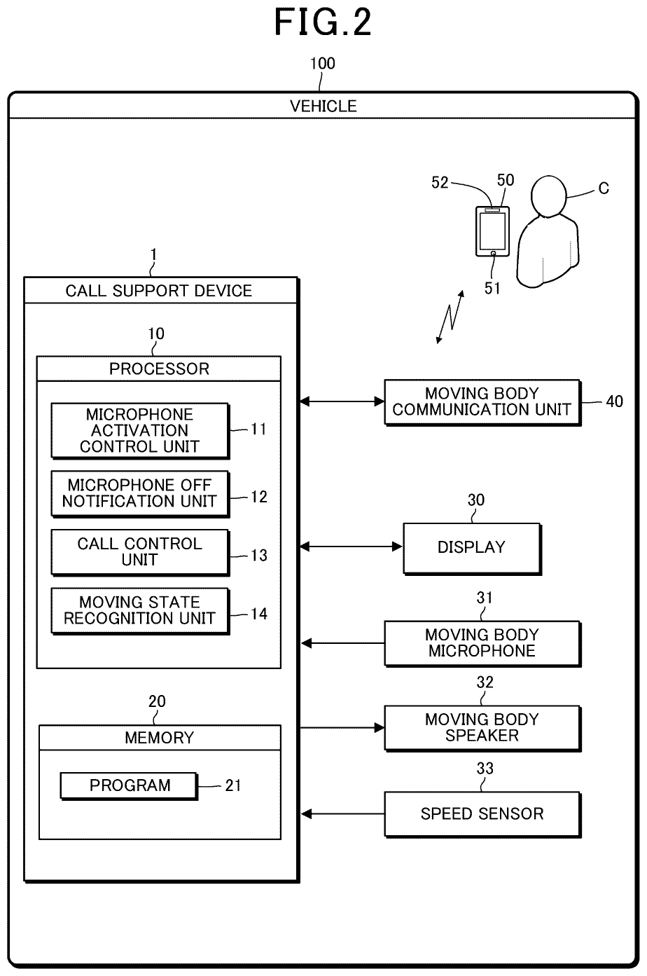

A configuration of the call support device 1 will be described with reference to FIG. 2. The call support device 1 is in connection with the display 30, the moving body microphone 31, the moving body speaker 32, the speed sensor 33, and the moving body communication unit 40. A touch operation signal on the display 30 is input into the call support device 1, and screen display of the display 30 is controlled by image data output from the call support device 1. An utterance signal of the occupant C input into the moving body microphone 31 is input into the call support device 1, and a voice signal of the person on the other end of the telephone talking with the occupant C output from the call support device 1 is amplified and output by the moving body speaker 32.

The call support device 1 is a control unit including a processor 10, a memory 20, and the like.

The memory 20 stores a program 21 for controlling the call support device 1. The processor 10 reads and executes the program 21, and functions as a microphone activation control unit 11, a microphone off notification unit 12, a call control unit 13, and a moving state recognition unit 14.

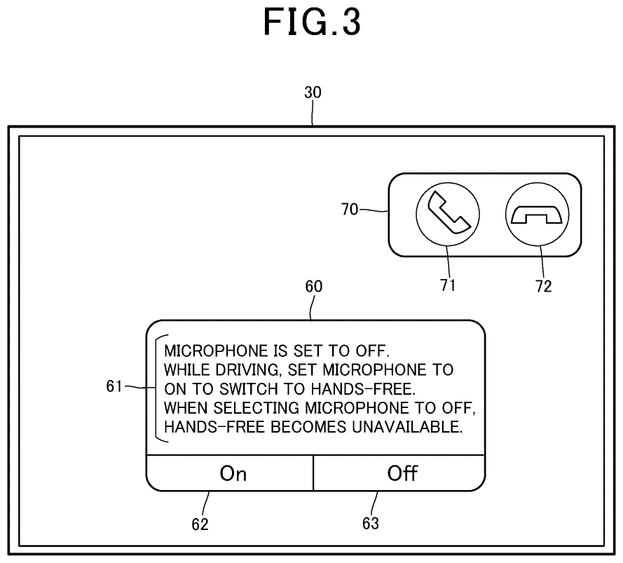

When the moving body microphone 31 is in off state, the microphone off notification unit 12 displays, on the display 30, a microphone off notification image 60, which is illustrated in FIG. 3. In the microphone off notification image 60, a message section 61, which notifies that the moving body microphone 31 is set to off and it is necessary to turn on the moving body microphone 31 in order to make a moving body hands-free call, a microphone on button 62 for turning on the moving body microphone 31, and a microphone off button 63 for turning off the moving body microphone 31 are displayed.

The microphone on button 62 and the microphone off button 63 correspond to a microphone switch in the present disclosure. Note that without being included in the microphone off notification image 60, the microphone on button 62 and the microphone off button 63 may be displayed in an area different from the microphone off notification image 60 of the display 30. In addition, the microphone switch may be a physical switch, instead of a touch button displayed on the display 30. Further, another configuration may be so set that there is one microphone switch, and whenever the microphone switch is operated, the moving body microphone 31 is switched between on state and off state.

The microphone activation control unit 11 turns on the moving body microphone 31 when the microphone on button 62 is operated, and turns off the moving body microphone 31 when the microphone off button 63 is operated. The call control unit 13 controls the moving body hands-free call, and displays, on the display 30, a call operation image 70 for giving an instruction to start or end the moving body hands-free call, as illustrated in FIG. 3.

The call operation image 70 includes a call start button 71 for giving an instruction to start a moving body hands-free call (an outgoing call), and a call end button 72 for giving an instruction to end the moving body hands-free call. The call control unit 13 starts controlling the moving body hands-free call in response to an operation on the call start button 71, and ends controlling the moving body hands-free call in response to an operation on the call end button 72. In addition, when the communication terminal 50 is receiving an incoming call (receiving a call from the person on the other end of the telephone), the call control unit 13 displays in a highlighted manner such as increasing the brightness of the call start button 71 (corresponding to an incoming call notification image in the present disclosure) to notify that an incoming call is being received.

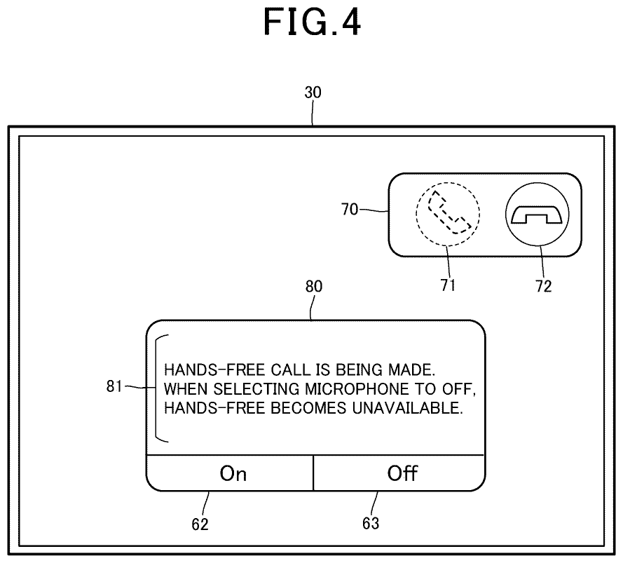

In addition, the call control unit 13 displays, on the display 30, a hands-free call ongoing image 80, which is illustrated in FIG. 4, when the moving body hands-free call is being made. The hands-free call ongoing image 80 includes a message section 81, which notifies that the moving body hands-free call is being made, and when the moving body microphone 31 is set to off, the moving body hands-free call becomes unavailable, a microphone on button 62, and a microphone off button 63.

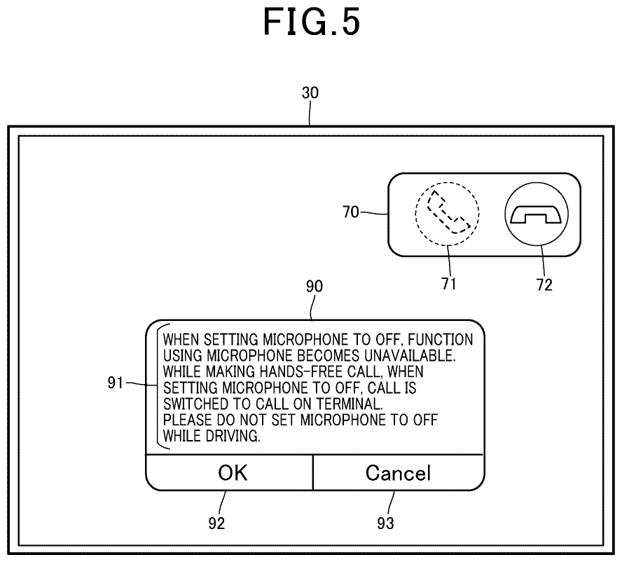

When the microphone off button 63 of the hands-free call ongoing image 80 is operated, the call control unit 13 displays, on the display 30, a microphone off confirmation image 90, which is illustrated in FIG. 5. The microphone off confirmation image 90 includes: a message section 91, which notifies that when the moving body microphone 31 is turned off, the moving body hands-free call ends and the call is switched to a terminal call; a microphone off decision button 92 for deciding an off instruction of the moving body microphone 31, and a cancel button 93 for canceling the off instruction of the moving body microphone 31.

The call control unit 13 turns off the moving body microphone 31 in response to an operation on the microphone off decision button 92, and maintains the moving body microphone 31 in on state in response to an operation on the cancel button 93. Hereinafter, details of processing performed by the microphone activation control unit 11, the microphone off notification unit 12, and the call control unit 13 will be described. The moving state recognition unit 14 recognizes that the vehicle 100 is traveling (the vehicle 100 is moving), based on a speed detection signal input from the speed sensor 33.

### 3. Handling Processing in a Case Where Moving Body Microphone is in Off State

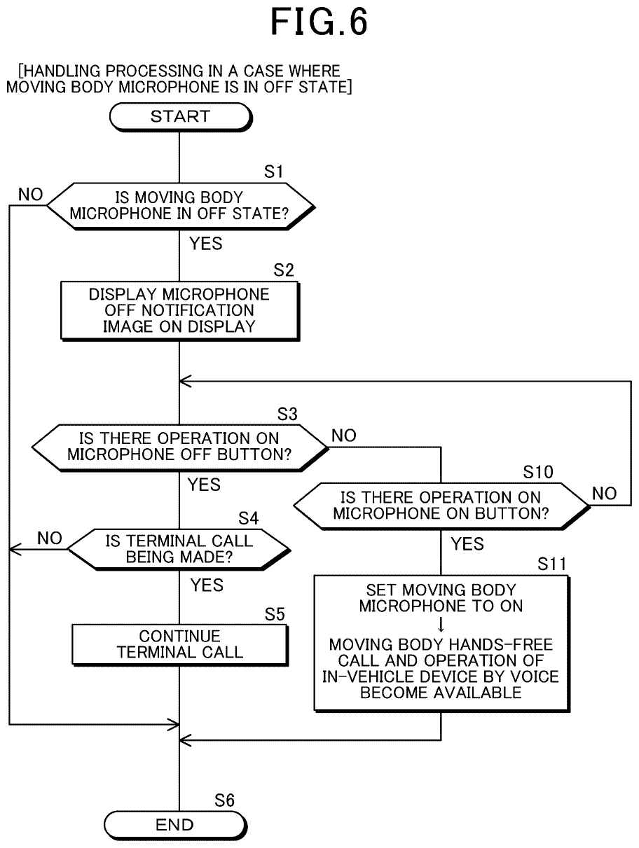

Processing performed by the call support device 1, in a case where the moving body microphone 31 is in off state, will be described with reference to a flowchart illustrated in FIG. 6. In step S1 of FIG. 6, the microphone off notification unit 12 determines whether the moving body microphone 31 is in off state. In a case where the moving body microphone 31 is in off state, the processing proceeds to step S2, and in a case where moving body microphone 31 is in on state, the processing proceeds to step S6.

In step S2, the microphone off notification unit 12 displays, on the display 30, the microphone off notification image 60, which is illustrated in FIG. 3. By loop processing in subsequent steps S3 and S4, the microphone activation control unit 11 determines whether the microphone off button 63 (see FIG. 3) is turned off in step S4, and determines whether the microphone on button 62 (see FIG. 3) is operated in step S10. Here, the microphone off notification image 60 may be displayed all the time while the moving body microphone 31 is set to off, or may be displayed only when a selection operation of selecting a function (a hands-free call, a voice communication application, or the like) that uses the moving body microphone 31 is detected.

When the microphone off button 63 is operated, the microphone activation control unit 11 advances the processing from step S3 to step S4. In step S4, the call control unit 13 determines whether a terminal call (a call using a microphone 51 and a speaker 52, which are provided in the communication terminal 50) is being made on the communication terminal 50. Then, the call control unit 13 advances the processing to step S6, in a case where the terminal call is not being made, and advances the processing to step S5, in a case where the terminal call is being made, to continue the terminal call without transmitting or receiving voices of the call to or from the communication terminal 50.

When the microphone on button 62 is operated, the microphone activation control unit 11 advances the processing from step S10 to step S11. In step S11, the microphone activation control unit 11 turns on the moving body microphone 31, and advances the processing to step S6. Accordingly, the moving body microphone 31 is in on state, and a moving body hands-free call and operations for in-vehicle devices by voice (navigation device, audio device, air conditioner, and the like) become available. In this case, after the moving body microphone 31 is set to on in step S11, in a case where the terminal call is being made and the moving body call is set to on, the call control unit 13 switches to a moving body hands-free call.

### 4. Incoming Call Handling Processing

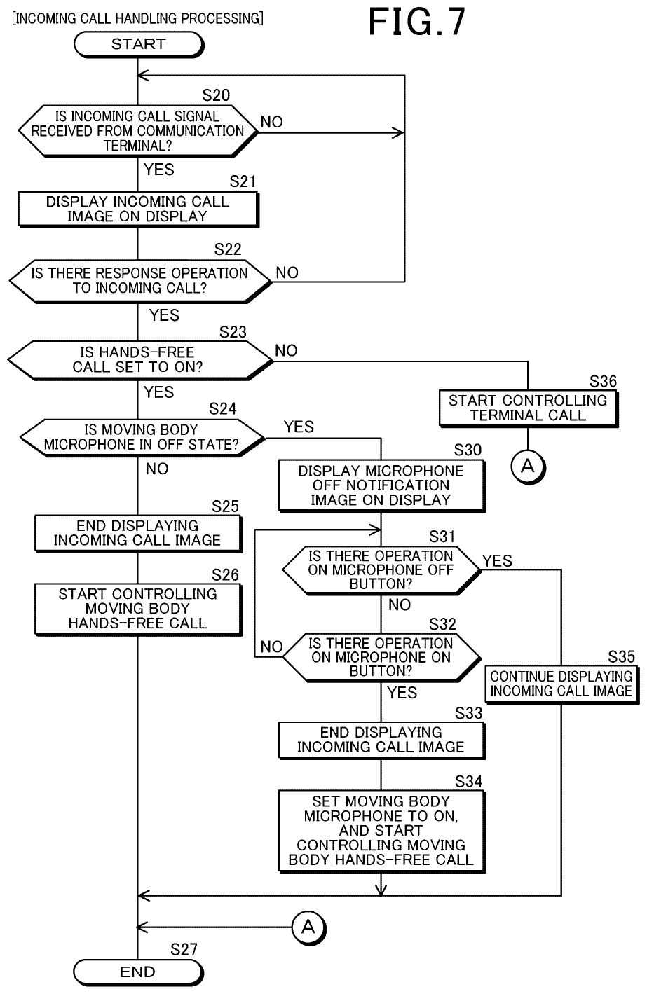

Handling processing, when the communication terminal 50 receives an incoming call, will be described with reference to a flowchart illustrated in FIG. 7. In step S20 of FIG. 7, when receiving an incoming call signal from the communication terminal 50, the call control unit 13 advances the processing to step S21.

In step S21, the call control unit 13 displays, on the display 30, an image of displaying the call start button 71 (see FIG. 3) in a highlighted manner as an incoming call image. In subsequent step S22, the call control unit 13 determines whether there is a response operation (an operation on the call start button 71 or a response operation on the communication terminal 50) to the incoming call. The call control unit 13 advances the processing to step S23 in a case where there is a response operation, and advances the processing to step S20 in a case where there is no response operation.

In subsequent step S23, the call control unit 13 determines whether the hands-free call is set to on in the communication terminal 50. Then, the call control unit 13 advances the processing to step S24 in a case where the hands-free call is set to on, and advances the processing to step S36 in a case where the hands-free call is set to off. In step S36, the call control unit 13 starts controlling the terminal call, and advances the processing to step S27. The terminal call on the communication terminal 50 is started, accordingly.

In step S24, the call control unit 13 determines whether the moving body microphone 31 is in off state. In a case where the moving body microphone 31 is in the state, the processing proceeds to step S30, and in a case where the moving body microphone 31 is in on state, the processing proceeds to step S25. In step S25, the call control unit 13 ends displaying the incoming call image. In subsequent step S25, the call control unit 13 transmits, to the communication terminal 50, the voices of the occupant C input into the moving body microphone 31, starts controlling the moving body hands-free call, and advances the processing to step S27.

In step S30, the call control unit 13 displays the microphone off notification image 60 (see FIG. 3) on the display 30 to notify the occupant C that it is necessary to set the moving body microphone 31 to on in order to make the moving body hands-free call. In subsequent step S31, the call control unit 13 determines whether the microphone off button 63 (see FIG. 3) has been operated. Then, the call control unit 13 advances the processing to step S35 in a case where the microphone off button 63 has been operated, and advances the processing to step S32 in a case where the microphone off button 63 has not been operated.

In step S35, the call control unit 13 continues displaying the incoming call image, and advances the processing to step S27. This continuously notifies the occupant C that it is necessary to set the moving body microphone to on, in order to make a moving body hands-free call. In addition, in step S32, the call control unit 13 determines whether the microphone on button 62 (see FIG. 3) has been operated. In a case where the microphone on button 62 has been operated, the processing proceeds to step S33, and in a case where the microphone on button 62 has not been operated, the processing proceeds to step S31.

In step S33, the call control unit 13 ends displaying the incoming call image. In subsequent step S34, the call control unit 13 turns on the moving body microphone 31, starts controlling a moving body hands-free call, and advances the processing to step S27.

### 5. Outgoing Call Handling Processing

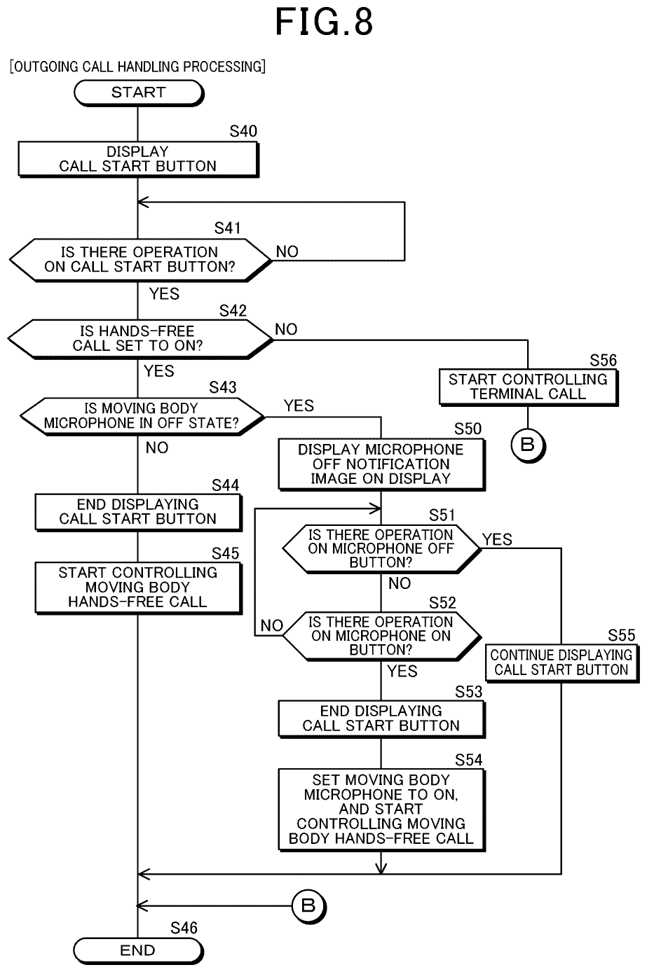

Handling processing, when the occupant C performs an operation of an outgoing call (starting a call), will be described with reference to a flowchart illustrated in FIG. 8. In step S40, the call control unit 13 displays the call start button 71 (see FIG. 3) on the display 30. In subsequent step S41, the call control unit 13 determines whether the call start button 71 has been operated, and advances the processing to step S42 in a case where the call start button 71 has been operated.

In step S42, the call control unit 13 determines whether the hands-free call is set to on in the communication terminal 50. Then, the call control unit 13 advances the processing to step S43 in a case where the hands-free call is set to on, and advances the processing to step S56 in a case where the hands-free call is set to off. In step $56, the call control unit 13 starts controlling the terminal call, and advances the processing to step S46. The terminal call on the communication terminal 50 is started, accordingly.

In step S43, the call control unit 13 determines whether the moving body microphone 31 is in off state, advances the processing to step S50 in a case where the moving body microphone 31 is in off state, and advances the processing to step S44 in a case where the moving body microphone 31 is in on state.

In step S44, the call control unit 13 ends displaying the call start button 71. In subsequent step S45, the call control unit 13 starts controlling the moving body hands-free call, by transmitting a signal for giving an instruction to make an outgoing call to a terminal of a person on the other end of the telephone to the communication terminal 50, transmitting the voices of the occupant C input into the moving body microphone 31 to the communication terminal 50, and outputting the voices of the person on the other end of the telephone transmitted from the communication terminal 50 from the moving body speaker 32, and then advances the processing to step S46.

In step S50, the call control unit 13 displays the microphone off notification image 60 (see FIG. 3) on the display 30. In subsequent step S51, the call control unit 13 determines whether the microphone off button 63 (see FIG. 3) has been operated. In a case where the microphone off button 63 has been operated, the processing proceeds to step S55, and in a case where the microphone off button 63 has not been operated, the processing proceeds to step S52.

In step S55, the call control unit 13 continues displaying the call start button 71, and advances the processing to step S46. By continuously displaying the call start button 71, it is possible to continuously notify the occupant C that it is possible to switch to the moving body hands-free call by setting the moving body microphone 31 to on.

In step S52, the call control unit 13 determines whether the microphone on button 62 (see FIG. 3) has been operated. In a case where the microphone on button 62 has been operated, the processing proceeds to step S53, and in a case where the microphone on button 62 has not been operated, the processing proceeds to step S51. In step S53, the call control unit 13 ends displaying the call start button 71. In subsequent step S54, the call control unit 13 turns on the moving body microphone 31, starts controlling the moving body hands-free call, and advances the processing to step S46.

### 6. Handling Processing During Moving Body Hands-Free Call

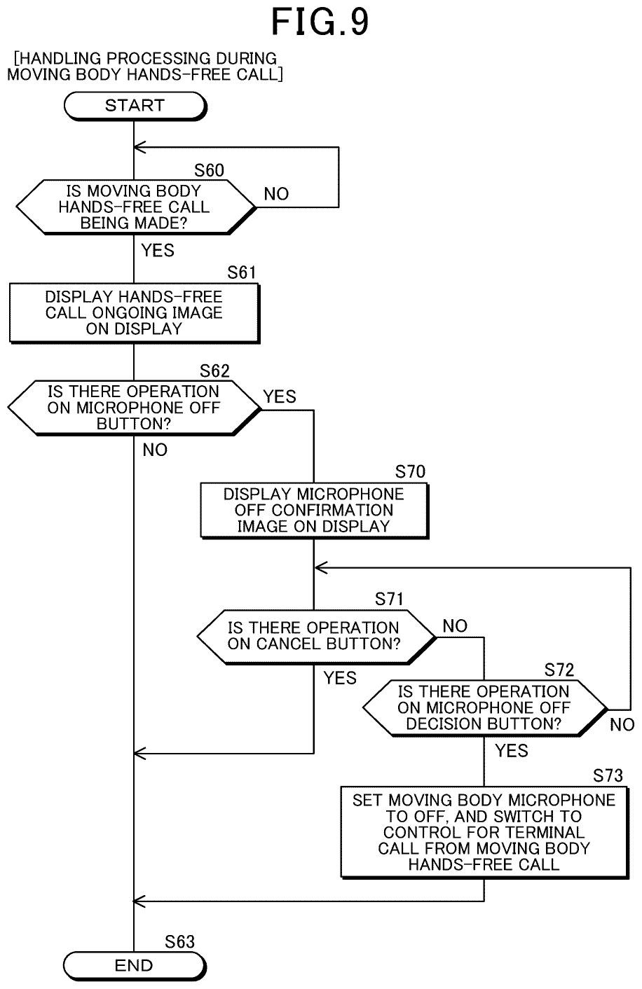

Handling processing, while the moving body hands-free call is being made, will be described with reference to a flowchart illustrated in FIG. 9. In step S60 of FIG. 8, the call control unit 13 determines whether the moving body hands-free call is being made, and advances the processing to step S61, in a case where the moving body hands-free call is being made.

In step S61, the call control unit 13 displays the hands-free call ongoing image 80 (see FIG. 4) on the display 30. In subsequent step S62, the call control unit 13 determines whether the microphone off button 63 (see FIG. 4) has been operated. Then, in a case where the microphone off button 63 has been operated, the call control unit 13 advances the processing to step S70, and in a case where the microphone off button 63 has not been operated, the call control unit advances the processing to step S63.

In step S70, the call control unit 13 displays the microphone off confirmation image 90 (see FIG. 5) on the display 30, and asks the occupant C whether the moving body microphone 31 should be really turned off. By loop processing in subsequent steps S71 and S72, the call control unit 13 determines whether the cancel button 93 (see FIG. 5) has been operated in step S71, and determines whether the microphone off decision button 92 (see FIG. 5) has been operated in step S72.

When the cancel button 93 is operated, the call control unit 13 advances the processing from step S71 to step S63. In this case, the moving body microphone 31 is maintained in on state. In addition, when the microphone off decision button 92 is operated, the call control unit 13 advances the processing from step S72 to step S73. In step S73, the call control unit 13 sets the moving body microphone 31 to off, switches from the moving body hands-free call to the control for the terminal call, and advances the processing to step S63.

### 7. Other Embodiments

In the above embodiment, the vehicle 100 is illustrated as the moving body in the present disclosure, However, the moving body in the present disclosure may be any moving body that includes a moving body microphone and that enables a moving body hands-free call made by a communication terminal that has been brought by an occupant and using the moving body microphone, and may be an aircraft, a ship, or the like.

In the above embodiment, the microphone off notification unit 12 performs the processing of displaying the microphone off notification image 60 on the display 30, as an output of a microphone off state notification in the present disclosure. As another embodiment, the microphone off notification unit 12 may perform processing of outputting, from the moving body speaker 32, a voice message for notifying that the moving body microphone 31 is in off state, as the output of the microphone off state notification in the present disclosure. In this case, the moving body speaker 32 corresponds to the moving body notification unit in the present disclosure. In addition, the display of the microphone off notification image 60 on the display 30 and the output of the voice message for notifying that the moving body microphone 31 is in off state from the moving body speaker 32 may be done in combination.

In the above embodiment, by the processing in accordance with the flowchart illustrated in FIG. 9, the call control unit 13 displays the hands-free call ongoing image 80 on the display 30 during the moving body hands-free call, and displays the microphone off confirmation image 90 on the display 30, when the microphone off button 63 is operated. As another embodiment, in a state in which the moving state recognition unit 14 recognizes that the vehicle 100 is traveling, while the moving body hands-free call is being made, the microphone activation control unit 11 may prohibit the moving body microphone 31 from being switched to off state. In this case, an image for notifying that an operation of turning off the moving body microphone 31 is prohibited may be displayed on the display 30.

Note that in order to facilitate understanding of the present invention, FIGS. 1 and 2 are schematic diagrams respectively illustrating the configurations of the vehicle 100 and the call support device 1, which are classified in accordance with main processing contents, and the configurations of the vehicle 100 and the call support device 1 may be formed in accordance with any other classification. In addition, the processing of each constitutional element may be performed by a single hardware unit, or may be performed by a plurality of hardware units. Further, the processing to be performed by each constituent element indicated in the flowcharts of FIGS. 6 to 9 may be performed by a single program or may be performed by a plurality of programs.

### 8. Configuration Supported by Above Embodiments

The above embodiments are specific examples of the following configurations.

Configuration 1: A call support device that supports a moving body call made by a communication terminal that has been brought into the moving body, the moving body call using a moving body microphone provided in the moving body, and the call support device includes: a call control unit configured to transmit a voice input into the moving body microphone to the communication terminal from a moving body communication unit provided in the moving body, and to make the moving body call; a microphone activation control unit configured to switch the moving body microphone between an on state and an off state in response to an operation on a microphone switch provided in the moving body; and a microphone off notification unit configured to cause a moving body notification unit provided in the moving body to output a microphone off state notification, in a case where the moving body microphone is in the off state and when making the moving body call.

According to the call support device in the configuration 1, it becomes possible to suppress degradation in operation performance of the moving body call using the moving body microphone and to protect the privacy of the occupant by turning off the moving body microphone.

Configuration 2: The call support device described in the configuration 1, the moving body notification unit is a display, and the microphone off notification unit performs processing of causing the display to display a microphone off notification image indicating that it is necessary to turn on the moving body microphone in order to make the moving body call, as an output of the microphone off state notification.

According to the call support device in the configuration 2, by displaying the microphone off notification image on the display, it becomes possible to notify the occupant that the moving body call is unavailable, and to support the occupant in selecting whether to maintain the moving body microphone in off state or switch the moving body microphone to on state.

Configuration 3: The call support device described in the configuration 2, in a state in which the microphone off notification image is displayed on the display, when the microphone activation control unit switches the moving body microphone from the off state to the on state in response to an operation on the microphone switch, the call control unit switches to the moving body call.

According to the call support device in the configuration 3, the moving body call becomes available in response to an operation of turning on the moving body microphone with use of the microphone switch, so that the operation by the occupant to start the moving body call can be facilitated.

Configuration 4: The call support device described in the configuration 2 or 3, in a case where the communication terminal detects switching a terminal call for making the call on the communication terminal using a terminal microphone provided in the communication terminal to the moving body call, and in a case where the moving body microphone is in the off state and the microphone off notification image is displayed on the display, the call control unit maintains a state in which the terminal call is being made, when an operation of turning off the moving body microphone is performed on the microphone switch.

According to the call support device in the configuration 4, in a case where the occupant performs an operation of turning off the moving body microphone and thus it is assumed that the occupant does not have an intention of making a moving body call, it becomes possible to maintain the state in which the terminal call is being made.

Configuration 5: The call support device described in one of the configurations 2 to 4, in a state in which communication is established between the communication terminal and the moving body communication unit, when the communication terminal receives an incoming call, the call control unit displays, on the display, an incoming call notification image for notifying the incoming call, and when the incoming call is answered from the incoming call notification image, and while the moving body microphone is in the off state and the microphone off notification image is displayed on the display, the call control unit continuously displays the incoming call notification image on the display, when an operation of turning off the moving body microphone is performed on the microphone switch.

According to the call support device in the configuration 5, by continuously displaying the incoming call notification image, it becomes possible to cause the occupant who has started the terminal call to recognize that it is possible to switch to the moving body call by turning on the moving body microphone.

Configuration 6: The call support device described in one of the configurations 2 to 5, in a state in which communication is established between the communication terminal and the moving body communication unit, the call control unit displays, on the display, a call start button for giving an instruction to start the call made by the communication terminal; and when the call start button is operated, and while the moving body microphone is in the off state and the microphone off notification image is displayed on the display, the call control unit continuously displays the call start button on the display, when an operation of turning off the moving body microphone is performed on the microphone switch.

According to the call support device in the configuration 6, by continuously displaying the call start button, it becomes possible to cause the occupant who has performed an operation of turning off the moving body microphone to recognize that it is possible to start the moving body call by switching on the moving body microphone.

Configuration 7: The call support device described in one of the configurations 2 to 6, while the moving body call is being made, when an operation of turning off the moving body microphone is performed on the microphone switch, the call control unit displays, on the display, a microphone off confirmation image for notifying that the moving body call becomes unavailable, when the moving body microphone is turned off.

According to the call support device in the configuration 7, in a case where the occupant in the moving body performs an operation of turning off the moving body microphone without intending to end the moving body call, it becomes possible to avoid a situation in which the moving body microphone is turned off and the moving body call ends against the occupant's intention.

Configuration 8: The call support device described in the configuration 7, the display is a touch panel display, and the call control unit causes the display to display the microphone off confirmation image including a microphone off decision button for deciding an instruction to turn off the moving body microphone, and turns off the moving body microphone, when the microphone off decision button is operated.

According to the call support device in the configuration 8, after the confirmation of the occupant in the moving body is obtained, the moving body microphone can be turned off.

Configuration 9: The call support device described in one of the configurations 1 to 8, further includes a moving state recognition unit configured to recognize that the moving body is in a moving state, and when the moving state recognition unit recognizes that the moving body is in the moving state, and while the moving body call is being made, the microphone activation control unit prohibits the moving body microphone from being switched to the off state.

According to the call support device in the configuration 9, while the moving body is in a moving state, it becomes possible to avoid a situation in which the moving body microphone is turned off and the moving body call is switched to the terminal call.

### REFERENCE SIGNS LIST

1 Call support device

### 10 Processor

11 Microphone activation control unit
12 Microphone off notification unit
13 Call control unit
14 Moving state recognition unit

### 20 Memory

### 21 Program

### 30 Display

31 Moving body microphone
32 Moving body speaker
33 Speed sensor
40 Moving body communication unit
50 Communication terminal
60 Microphone off notification image
61 Microphone off message
62 Microphone on button
63 Microphone off button
70 Call operation image
71 Call start button
72 Call end button
80 Hands-free call ongoing image
90 Microphone off confirmation image
92 Microphone off decision button
93 Cancel button

### 100 Vehicle

### C Occupant

What is claimed is:

1. A call support device that supports a moving body call made by a communication terminal that has been brought into a moving body, the moving body call using a moving body microphone provided in the moving body, the call support device comprising:
a call control unit configured to transmit a voice input into the moving body microphone to the communication terminal from a moving body communication unit provided in the moving body, and to make the moving body call;
a microphone activation control unit configured to switch the moving body microphone between an on state and an off state in response to an operation on a microphone switch provided in the moving body; and
a microphone off notification unit configured to cause a moving body notification unit provided in the moving body to output a microphone off state notification, in a case where the moving body microphone is in the off state and when making the moving body call.

2. The call support device according to claim 1, wherein
the moving body notification unit is a display, and
the microphone off notification unit performs processing of causing the display to display a microphone off notification image indicating that it is necessary to turn on the moving body microphone in order to make the moving body call, as an output of the microphone off state notification.

3. The call support device according to claim 2, wherein
in a state in which the microphone off notification image is displayed on the display, when the microphone activation control unit switches the moving body microphone from the off state to the on state in response to an operation on the microphone switch, the call control unit switches to the moving body call.

4. The call support device according to claim 2, wherein
in a case where the communication terminal detects switching a terminal call for making the call on the communication terminal using a terminal microphone provided in the communication terminal to the moving body call, and in a case where the moving body microphone is in the off state and the microphone off notification image is displayed on the display,
the call control unit
maintains a state in which the terminal call is being made, when an operation of turning off the moving body microphone is performed on the microphone switch.

5. The call support device according to claim 2, wherein
in a state in which communication is established between the communication terminal and the moving body communication unit, when the communication terminal receives an incoming call, the call control unit displays, on the display, an incoming call notification image for notifying the incoming call, and
when the incoming call is answered from the incoming call notification image, and while the moving body microphone is in the off state and the microphone off notification image is displayed on the display, the call control unit continuously displays the incoming call notification image on the display, when an operation of turning off the moving body microphone is performed on the microphone switch.

6. The call support device according to claim 2, wherein
in a state in which communication is established between the communication terminal and the moving body communication unit, the call control unit displays, on the display, a call start button for giving an instruction to start the call made by the communication terminal; and
when the call start button is operated, and while the moving body microphone is in the off state and the microphone off notification image is displayed on the display, the call control unit continuously displays the call start button on the display, when an operation of turning off the moving body microphone is performed on the microphone switch.

7. The call support device according to claim 2, wherein
while the moving body call is being made, when an operation of turning off the moving body microphone is performed on the microphone switch, the call control unit displays, on the display, a microphone off confirmation image for notifying that the moving body call becomes unavailable, when the moving body microphone is turned off.

8. The call support device according to claim 7, wherein
the display is a touch panel display, and
the call control unit causes the display to display the microphone off confirmation image including a microphone off decision button for deciding an instruction to turn off the moving body microphone, and turns off the moving body microphone, when the microphone off decision button is operated.

9. The call support device according to claim 1, further comprising
a moving state recognition unit configured to recognize that the moving body is in a moving state, and
when the moving state recognition unit recognizes that the moving body is in the moving state, and while the moving body call is being made, the microphone activation control unit prohibits the moving body microphone from being switched to the off state.
